(19) United States
(12) Patent Application Publication
(10) Pub. No.: US 2024/0219768 A1
(43) Pub. Date: Jul. 4, 2024

(54) Polarizing Plate and Display Apparatus Comprising the Same

(71) Applicant: LG Display Co., Ltd., Seoul (KR)

(72) Inventor: YiRang Lim, Paju-si (KR)

(21) Appl. No.: 18/532,844

(22) Filed: Dec. 7, 2023

(30) Foreign Application Priority Data
Dec. 28, 2022 (KR) 10-2022-0186516

(51) Int. Cl. G02F 1/1335; G02B 27/28

(52) U.S. Cl. CPC G02F 1/133533; G02B 27/288; G02F 2203/055; G02F 2203/07

(57) ABSTRACT

A polarizing plate is provided, which comprises a polarizing layer absorbing incident light in a first direction and transmitting incident light in a second direction perpendicular to the first direction, first and second support layers respectively formed on a lower surface and an upper surface of the polarizing layer, and an adhesive layer formed on a lower surface of the first support layer, wherein the adhesive layer is mixed with a dye. A polarizing plate is further provided, which comprises a polarizing layer absorbing incident light in a first direction and transmitting incident light in a second direction perpendicular to the first direction, first and second support layers respectively formed on a lower surface and an upper surface of the polarizing layer, and an adhesive layer formed on a lower surface of the first support layer, and further comprises at least one color layer formed on the adhesive layer and mixed with a dye.

### CROSS-REFERENCE TO RELATED APPLICATIONS

This application claims the benefit of the Korean Patent Application No. 10-2022-0186516 filed on Dec. 28, 2022, which is hereby incorporated by reference as if fully set forth herein.

### BACKGROUND

### Field of the Invention

The present disclosure relates to a polarizing plate and a display apparatus comprising the same.

### Discussion of the Related Art

With the advancement of the information age, the demand for a display apparatus for displaying an image has increased with various forms. Therefore, various types of display apparatuses such as a liquid crystal display (LCD), a plasma display panel (PDP) and an electroluminescence display (ELD) have been recently used.

Generally, the liquid crystal display apparatus include a liquid crystal display panel, an upper polarizing plate provided on an upper portion of the liquid crystal display panel, a lower polarizing plate provided on a lower portion of the liquid crystal display panel, and a backlight unit that provides light to the lower polarizing plate. At this time, the lower polarizing plate polarizes light incident from the backlight unit, and the upper polarizing plate polarizes light incident from the liquid crystal display panel, thereby emitting the polarized light. Recently, studies for a polarizing plate structure to increase light efficiency of a display apparatus are ongoing.

### SUMMARY

The present disclosure has been made in view of the above problems and it is an object of the present disclosure to provide a display apparatus that adjusts a spectrum of white light and improves a color reproduction rate.

In addition to the objects of the present disclosure as mentioned above, additional objects and features of the present disclosure will be clearly understood by those skilled in the art from the following description of the present disclosure.

In accordance with an aspect of the present disclosure, the above and other objects can be accomplished by a polarizing plate comprising a polarizing layer absorbing incident light in a first direction and transmitting incident light in a second direction perpendicular to the first direction, first and second support layers respectively formed on a lower surface and an upper surface of the polarizing layer, and an adhesive layer formed on a lower surface of the first support layer, wherein the adhesive layer is mixed with a dye.

In accordance with another aspect of the present disclosure, the above and other objects can be accomplished by a polarizing plate comprising a polarizing layer absorbing incident light in a first direction and transmitting incident light in a second direction perpendicular to the first direction, first and second support layers respectively formed on a lower surface and an upper surface of the polarizing layer, and an adhesive layer formed on a lower surface of the first support layer, and further comprising at least one color layer formed on the adhesive layer and mixed with a dye.

According to the present disclosure, since the lower polarizing plate containing a dye is formed to absorb blue light, the spectrum of white light may be adjusted, and a color reproduction rate may be improved.

It is to be understood that both the foregoing general description and the following detailed description are exemplary and explanatory and are intended to provide further explanation of the inventive concepts as claimed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a cross-sectional view illustrating a display apparatus comprising a polarizing plate according to one embodiment of the present disclosure;

FIG. 2 is a cross-sectional view illustrating a polarizing plate according to the first embodiment of the present disclosure;

FIG. 3 is a cross-sectional view illustrating a polarizing plate according to the second embodiment of the present disclosure;

FIG. 4 is a cross-sectional view illustrating a polarizing plate according to the third embodiment of the present disclosure;

FIG. 5 is a cross-sectional view illustrating a polarizing plate according to the fourth embodiment of the present disclosure;

FIG. 6 is a cross-sectional view illustrating a polarizing plate according to the fifth embodiment of the present disclosure;

FIG. 7 is a cross-sectional view illustrating a polarizing plate according to the sixth embodiment of the present disclosure; and

FIGS. 8a and 8b are a graph and a table, respectively, according to one embodiment of the present disclosure.

### DETAILED DESCRIPTION OF THE DISCLOSURE

Advantages and features of the present disclosure and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete and will fully convey the scope of the present disclosure to those skilled in the art. Further, the present disclosure is only defined by scopes of claims.

A shape, a size, a ratio, an angle and a number disclosed in the drawings for describing embodiments of the present disclosure are merely an example and thus, the present disclosure is not limited to the illustrated details. Like reference numerals refer to like elements throughout the specification. In the following description, when the detailed description of the relevant known function or configuration is determined to unnecessarily obscure the important point of the present disclosure, the detailed description will be omitted. In a case where comprise, have and include described in the present disclosure are used, another portion may be added unless only˜ is used. The terms of a singular form may include plural forms unless referred to the contrary.

In construing an element, the element is construed as including an error range although there is no explicit description.

In describing a position relationship, for example, when the position relationship is described as upon˜, above˜, below˜ and next to˜, one or more portions may be arranged between two other portions unless just or direct is used.

In describing a temporal relationship, for example, when the temporal order is described as after˜, subsequent˜, next˜ and before˜, a case which is not continuous may be included unless just or direct is used.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Features of various embodiments of the present disclosure may be partially or overall coupled to or combined with each other and may be variously inter-operated with each other and driven technically as those skilled in the art can sufficiently understand. The embodiments of the present disclosure may be carried out independently from each other or may be carried out together in co-dependent relationship.

Hereinafter, a preferred embodiment of the present disclosure will be described in detail with reference to the accompanying drawings.

FIG. 1 is a cross-sectional view illustrating a display apparatus comprising a polarizing plate according to one embodiment of the present disclosure.

Referring to FIG. 1, the display apparatus includes a display panel, an upper polarizing plate 400 disposed on an upper portion of the display panel, a lower polarizing plate 500 disposed on a lower portion of the display panel and a backlight unit 600 supplying light to the lower polarizing plate 500. The display apparatus may include other components or units not shown in the Figure.

The display panel may include a thin film transistor substrate 100, a color filter substrate 200 formed to face the thin film transistor substrate 100 and a liquid crystal layer 300 formed between the thin film transistor substrate 100 and the color filter substrate 200. Other layers or elements may also be included in the display panel, which are omitted herein.

The thin film transistor substrate 100 may include a first substrate 110 and a thin film transistor array 120. The thin film transistor array 120 is formed on the first substrate 110, and may include a plurality of thin film transistors and driving circuits.

The color filter substrate 200 may include a second substrate 210, a color filter 220 and a black matrix 230. The color filter 220 may be formed on the second substrate 210, and may transmit red light R, green light G and blue light B, respectively. Color of the light transmitted by the color filter 220 is not limited to red, green and blue, and can be other color such as cyan, magenta, yellow, etc. In addition, the black matrix 230 may be formed between the color filters 220 to prevent light leakage from occurring.

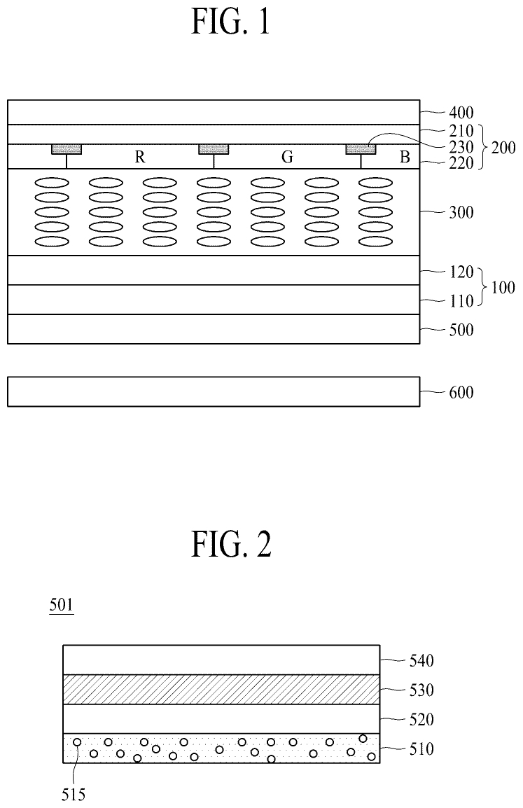

The upper polarizing plate 400 may polarize light incident from the display panel and emit the polarized light, and the lower polarizing plate 500 may polarize light incident from the backlight unit 600 and emit the polarized light. The upper polarizing plate 400 may be implemented as a polarizing plate to which a linear polarizing plate and a phase retardation film are bonded, or a circular polarizing plate. The upper polarizing plate 400 may include a polymer film including, as a main component, polyvinyl alcohol (PVA)-based resin including iodine or dichroic dye and a protection film disposed on both sides of the polymer film. Iodine or dichroic dye may elongate to one axis and may be aligned in one direction. Also, the upper polarizing plate 400 may include a material other than polyvinyl alcohol-based resin. For example, the upper polarizing plate 400 may use an O-type polarization element where a liquid crystal composition including a dichroic material and a liquid crystal compound is aligned in a certain direction and an E-type polarizing material where a lyotropic liquid crystal is aligned in a certain direction. In this case, the lower polarizing plate 500 may include a dye, and will be described in detail with reference to lower polarizing plates 501 to 506 of the first to sixth embodiments in FIGS. 2 to 7.

FIG. 2 is a cross-sectional view illustrating a lower polarizing plate 501 according to the first embodiment of the present disclosure.

Referring to FIG. 2, the lower polarizing plate 501 according to the first embodiment of the present disclosure may include an adhesive layer 510, a first support layer 520, a polarizing layer 530 and a second support layer 540.

The polarizing layer 530 may absorb light incident in a first direction and transmit the incident light in a second direction perpendicular to the first direction. Therefore, the polarizing layer 530 may perform a polarizing function. In addition, the polarizing layer 530 may be formed by adsorbing an organic dye or a halogen salt crystal such as iodine to a poly-vinyl alcohol (PVA) film and then stretching the PVA film in a specific direction so that iodine crystals are aligned in parallel in the stretching direction.

The first and second support layers 520 and 540 may be respectively formed on lower and upper surfaces of the polarizing layer 530 to support and protect the polarizing layer 530. The first and second support layers 520 and 540 may be formed of a material that is optically transparent and has high mechanical strength to physically protect the polarizing layer 530. For example, the first and second support layers 520 and 540 may be made of at least one material of an acetate-based resin such as triacetyl cellulose (TAC), diacetyl cellulose (DAC) or the like, a polyester-based resin such as polyvinyl alcohol (PVA), poly ether sulfone (PES), polyetheretherketone (PEEK), polyetherimide (PEI), polyethylenenaphthalate (PEN), polyethyleneterephthalate (PET), or the like, a polyethersulfone-based resin, a polycarbonate-based resin (PC), a polyamide-based resin, a polyimide-based resin, a polyolefin-based resin such as polyethylene (PE), polypropylene (PP), or the like, an acrylic-based resin such as cyclo olefin copolymer (COC), poly(methylmethacrylate) (PMMA), or the like, cycloolefin polymer (COP) such as a polynorbornene-based resin, or a combination thereof.

The adhesive layer 510 may serve to easily attach the lower polarizing plate 501 to the outside. For example, the adhesive layer 510 may be made of at least one of an acrylic-based adhesive, an urethane-based adhesive, an epoxy adhesive, a silicone-based adhesive, a polyester-based adhesive, a polyurethane-based adhesive, a polyether-based adhesive, or a rubber-based adhesive.

In this case, a dye 515 may be coated on the adhesive layer 510. That is, the adhesive layer 510 may be formed by mixing the aforementioned adhesive with the dye 515.

The dye 515 may absorb light of a short wavelength having high energy and drop the absorbed light to a ground state to emit light of a long wavelength. In particular, the dye 515 may absorb light of a blue (B) wavelength band of 455 nm or less, but is not limited thereto. For example, the dye 515 can absorb light of another wavelength band. Therefore, in the first embodiment, intensity of some wavelength bands may be reduced by using the adhesive layer 510 that includes the dye 515, so that a spectrum of white light incident from the backlight unit 600 may be changed. In particular, the dye 515 may reduce intensity of the blue (B) wavelength band of 455 nm or less.

That is, in the first embodiment of the present disclosure the dye 515 is additionally mixed with the adhesive layer 510. Therefore, since the spectrum of the white light may be changed without additionally changing the design of the backlight unit 600, additional process costs may be minimized. In addition, since the layer on which the dye 515 is formed is disposed on the lower surface of the first support layer 520, an intrinsic function of the polarizing layer 340 may be maintained.

In addition, in order to reduce the intensity of the blue (B) wavelength band, when the wavelength bands of the backlight unit 600 are simply shifted, a color mixture may occur in a green (G) wavelength band adjacent to the blue (B) wavelength band. However, in the first embodiment of the present disclosure, intensity of light corresponding to a specific wavelength band among blue (B) light may be reduced without adjusting all of the blue (B) wavelength bands through the dye 515. Therefore, a color mixture of colors different from the blue (B) color may be avoided, whereby a color reproduction rate may be improved.

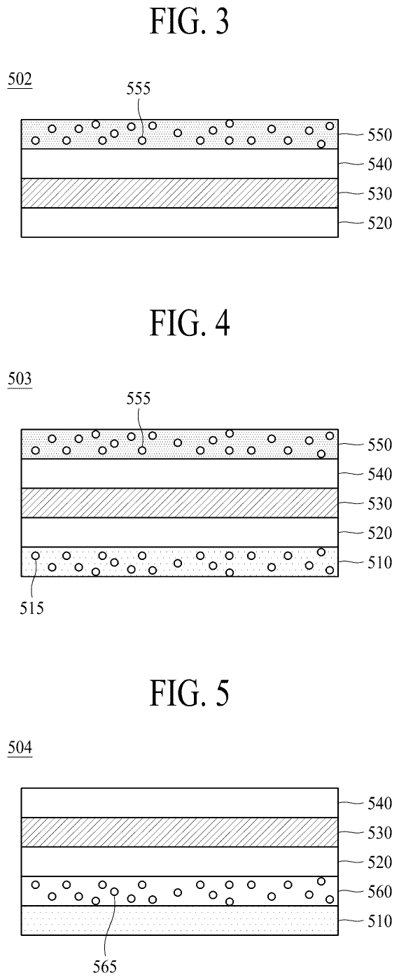

FIG. 3 is a cross-sectional view illustrating a polarizing plate 502 according to the second embodiment of the present disclosure.

Referring to FIG. 3, the lower polarizing plate 502 according to the second embodiment of the present disclosure may include a first support layer 520, a polarizing layer 530, a second support layer 540 and a compensation layer 550.

The first support layer 520, the polarization layer 530 and the second support layer 540, which are disclosed in FIG. 3, are substantially the same as those of the display apparatus shown in FIG. 2, and thus their repeated description will be omitted.

The compensation layer 550 may be formed on an upper surface of the second support layer 540. The compensation layer 550 may include a surface-treated coating composition that includes a composition for forming an anti-glare layer, a hard coating composition, a light-transmissive resin, light-transmissive particles, a photopolymerization initiator and a solvent. The hard coating may include eucryptite or spodumene which is formed of silica (SiO2), alumina (Al2O3), and lithium oxide (Li2O) or at least one of zirconium tungstate (ZrW2O8), hafnium tungstate (HfW2O8), zirconium molybdate (ZrMO2O8), and hafnium molybdate (HfMO2O8). In addition, the compensation layer 550 may perform a function of preventing visibility degradation due to light reflection or light refraction which may occur on an upper surface of the lower polarizing plate 502. The compensation layer 550 may include a composition for forming a low reflection layer, which includes a fluorine-based resin such as polyvinylidene fluoride, vinylidene fluoride-tetrafluoroethylene copolymers, vinylidene fluoride-trifluoroethylene copolymers, polyvinylidene fluoride-trifluoroethylene copolymers, and polyvinylidene fluoride-tetrafluoroethylene copolymers, a light-transmissive resin, fine particles having pores, a photopolymerization initiator and a solvent.

In this case, a dye 555 may be coated on the compensation layer 550. That is, the compensation layer 550 may be formed by mixing the composition for forming the low reflection layer with the dye 555.

As described above with reference to FIG. 2, the dye 555 may absorb light of a short wavelength having high energy, and may drop the absorbed light to a ground state to emit light of a long wavelength. In particular, the dye 555 may absorb light of a blue (B) wavelength band of 455 nm or less. Therefore, in the second embodiment, intensity of some wavelength bands may be reduced through the compensation layer 550 that includes the dye 555, so that a spectrum of white light incident from the backlight unit 600 may be changed. In particular, the dye 555 may reduce intensity of the blue (B) wavelength band of 455 nm or less.

FIG. 4 is a cross-sectional view illustrating a polarizing plate 503 according to the third embodiment of the present disclosure.

The display apparatus according to FIG. 4 discloses substantially the same structure as that of the display apparatus of FIG. 3 except for the structure of the adhesive layer 510. Therefore, the same reference numerals will be given to the same elements as those of the display apparatus shown in FIG. 4, and their repeated description will be omitted.

The display apparatus according to FIG. 4 further discloses an adhesive layer 510 formed on a lower surface of the first support layer 520 as compared with FIG. 3. In addition, the adhesive layer 510 includes a dye 515, and may disclose the same features as those of the adhesive layer 510 and the dye 515, which are described in FIG. 2.

That is, the third embodiment of the present disclosure may disclose an adhesive layer 510 containing a dye 515 and a compensation layer 550 containing a dye 555. The dyes 515 and 555 contained in the adhesive layer 510 and the compensation layer 550 may be the same materials, but are not limited thereto. In addition, as described above, the dyes 515 and 555 may absorb light of a short wavelength having high energy, and may drop the absorbed light to a ground state to emit light of a long wavelength. At this time, in the third embodiment, since the dyes 515 and 555 are mixed with the adhesive layer 510 and the compensation layer 550, a spectrum of white light incident from the backlight unit 600 may be changed more effectively than the first and second embodiments. In particular, intensity of the blue (B) wavelength band of 455 nm or less may be further reduced.

FIG. 5 is a cross-sectional view illustrating a polarizing plate 504 according to the fourth embodiment of the present disclosure.

The display apparatus according to FIG. 5 discloses substantially the same structure as that of the display apparatus of FIG. 2 except for the structure of the adhesive layer 510 and a first color layer 560. Therefore, the same reference numerals will be given to the same elements as those of the display apparatus shown in FIG. 2, and their repeated description will be omitted.

The adhesive layer 510 of the display apparatus according to FIG. 5 may not include the dye 515 as compared with FIG. 2. That is, the adhesive layer 510 is made of an adhesive, and may be made of at least one of an acrylic adhesive, an urethane-based adhesive, an epoxy adhesive, a silicone-based adhesive, a polyester-based adhesive, a polyurethane-based adhesive, a polyether-based adhesive, or a rubber-based adhesive.

The display apparatus of FIG. 5 further discloses the first color layer 560 formed between the adhesive layer 510 and the first support layer 520. The first color layer 560 may be made of a transparent resin. For example, the first color layer 560 may be made of at least one of an acrylic-based resin, a polycarbonate-based resin, a silicon-based resin, a polystyrene-based resin, a polyimide-based resin, a polysiloxane-based resin, an epoxy-based resin, or a copolymer resin thereof. At this time, a dye 565 may be coated on the first color layer 560. That is, the first color layer 560 may be formed by mixing the aforementioned resin with the dye 565.

As described above, the dye 565 may absorb light of a short wavelength having high energy and drop the absorbed light to a ground state to emit light of a long wavelength. In particular, the dye 565 may absorb light of a blue (B) wavelength band of 455 nm or less. Therefore, in the fourth embodiment, intensity of some wavelength bands may be reduced through the first color layer 560 that includes the dye 565, so that a spectrum of white light incident from the backlight unit 600 may be changed. In particular, the dye 565 may reduce intensity of the blue (B) wavelength band of 455 nm or less.

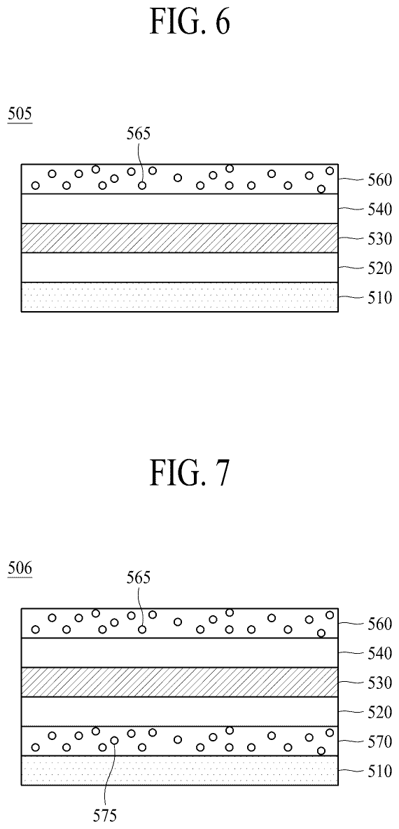

FIG. 6 is a cross-sectional view illustrating a polarizing plate 505 according to the fifth embodiment of the present disclosure.

The display apparatus according to FIG. 6 discloses substantially the same structure as that of the display apparatus of FIG. 5 except for the structure of the first color layer 560. Therefore, the same reference numerals will be given to the same elements as those of the display apparatus shown in FIG. 5, and their repeated description will be omitted.

The display apparatus according to FIG. 6 discloses the first color layer 560 in the same manner as FIG. 5. In this case, the first color layer 560 may be formed on the upper surface of the second support layer 540. In addition, the first color layer 560 may include a dye 565.

FIG. 7 is a cross-sectional view illustrating a polarizing plate 506 according to the sixth embodiment of the present disclosure.

The display apparatus according to FIG. 7 discloses substantially the same structure as that of the display apparatus of FIG. 6 except for a structure of a second color layer 570. Therefore, the same reference numerals will be given to the same elements as those of the display apparatus shown in FIG. 6, and their repeated description will be omitted.

The display apparatus according to FIG. 7 additionally discloses the second color layer 570 as compared with FIG. 6. The second color layer 570 may be formed between the adhesive layer 510 and the first support layer 530, and the first color layer 560 may be formed on the upper surface of the second support layer 540. In addition, the first and second color layers 560 and 570 may include dyes 565 and 575, respectively. The dyes 565 and 575 included in the first and second color layers 560 and 570 may be the same materials, but are not limited thereto. In addition, as described above, the dyes 565 and 575 may absorb light of a short wavelength having high energy, and may drop the absorbed light to a ground state to emit light of a long wavelength. At this time, in the sixth embodiment, since the dyes 565 and 575 are mixed with the first and second color layers 560 and 570, a spectrum of white light incident from the backlight unit 600 may be changed more effectively than the fourth and fifth embodiments. In particular, intensity of the blue (B) wavelength band of 455 nm or less may be further reduced.

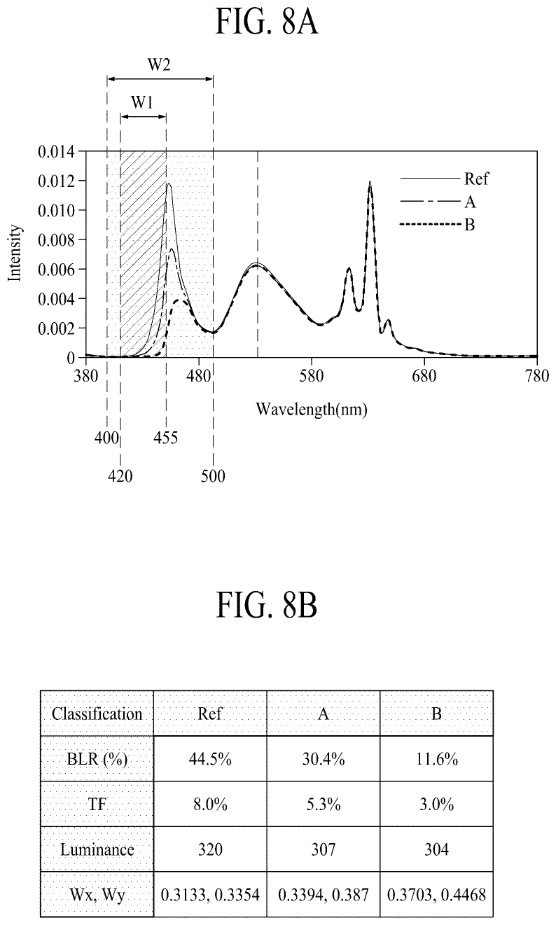

FIGS. 8A and 8B are a graph and a table, respectively, according to one embodiment of the present disclosure.

FIG. 8A illustrates a spectrum of light emitted from first to third display apparatuses Ref, A and B. That is, FIG. 8A illustrates the intensity of light according to each wavelength band of light emitted from the display apparatus. Unlike the lower polarizing plate 500 of the present disclosure, the first display apparatus Ref is a display apparatus that uses a polarizing plate which does not contain a dye. The second display apparatus A is a display apparatus that uses the lower polarizing plate 500 according to any one of the first to sixth embodiments of the present disclosure. The third display apparatus B is a display apparatus that uses the lower polarizing plate 500 that is changed from the embodiment of the second display apparatus A in some design. For example, the third display apparatus B may disclose that a material of a dye or the amount of a dye is adjusted from that of the lower polarizing plate 500 of the second display apparatus A, but is not limited thereto.

In this case, a first wavelength band W1 is an area of 400 nm to 500 nm, and may be an area from which blue (B) light is emitted. In addition, the second wavelength band W2 is an area of 420 nm to 455 nm, and may be an area from which blue (B) light of a short wavelength among the blue (B) light is emitted.

Referring to FIG. 8A, the intensity of light in the second and third display apparatuses A and B may be smaller than that of the first display apparatus Ref at the first wavelength band W1. In particular, at the second wavelength band W2, a maximum value of intensity of light of a first graph Ref is about 0.012, and a maximum value of intensity of light of the second and third display apparatuses A and B may be about 0.007 and 0.004. That is, the display apparatus of the present disclosure may reduce intensity of light of a blue (B) wavelength band, particularly intensity of a blue (B) wavelength band of 455 nm or less, as compared with the display apparatus comprising a polarizing plate having no dye.

Referring to FIG. 8B, characteristics of light emitted from the first to third display apparatuses Ref, A and B are shown.

BLR means a ratio of blue (B) light in the spectrum of light, and a BLR value of the second and third display apparatuses A and B may be lower than that of the first display apparatus Ref. That is, the ratio of blue (B) light may be reduced in the spectrum of light emitted from the display apparatus of the present disclosure as compared with the display apparatus comprising a polarizing plate having no dye. In addition, TF means the risk of blue (B) light to a user and in particular, means the risk of light in a blue (B) wavelength band of 455 nm or less. As described above, since the ratio of blue (B) light is reduced in the second and third display apparatuses A and B as compared with the display apparatus comprising a polarizing plate having no dye, the TF value may be reduced similarly. That is, the present disclosure may reduce the risk of light emitted from the display apparatus as compared with the display apparatus comprising a polarizing plate having no dye.

Meanwhile, referring to FIG. 8B, it may be noted that the first display apparatus Ref is similar to the second and third display apparatuses A and B in values of luminance and color coordinates Wx and Wy of light. That is, as described above, the present disclosure may reduce the ratio of blue (B) light and minimize attenuation of luminance and color coordinates Wx and Wy as compared with the display apparatus comprising a polarizing plate having no dye.

According to the present disclosure, the following advantageous effects may be obtained.

According to the present disclosure, since the polarizing plate containing a dye is formed to absorb blue light, the spectrum of white light may be adjusted, and a color reproduction rate may be improved.

It will be apparent to those skilled in the art that the present disclosure described above is not limited by the above-described embodiments and the accompanying drawings and that various substitutions, modifications and variations may be made in the present disclosure without departing from the spirit or scope of the disclosures. Consequently, the scope of the present disclosure is defined by the accompanying claims and it is intended that all variations or modifications derived from the meaning, scope and equivalent concept of the claims fall within the scope of the present disclosure.

What is claimed is:

1. A polarizing plate comprising:
a polarizing layer absorbing incident light in a first direction and transmitting incident light in a second direction perpendicular to the first direction;
first and second support layers formed below a lower surface and above an upper surface, respectively, of the polarizing layer; and
a combined layer formed below a lower surface of the first support layer and/or above an upper surface of the second support layer,
wherein the combined layer includes a dye.

2. The polarizing plate of claim 1, wherein the combined layer includes an adhesive layer formed below the lower surface of the first support layer and mixed with the dye.

3. The polarizing plate of claim 1,
wherein the combined layer includes a compensation layer formed on the upper surface of the second support layer by mixing a surface-treated coating composition with the dye.

4. The polarizing plate of claim 1, wherein the combined layer includes a compensation layer formed on the upper surface of the second support layer by mixing a surface-treated coating composition with a first dye and an adhesive layer formed below the lower surface of the first support layer and mixed with a second dye.

5. The polarizing plate of claim 1, wherein the dye absorb light of a specific wavelength band.

6. A display apparatus comprising:
a display panel displaying an image;
a backlight unit disposed below the display panel to supply light; and
the polarizing plate of claim 1 disposed between the display panel and the backlight unit.

7. A polarizing plate comprising:
a polarizing layer absorbing incident light in a first direction and transmitting incident light in a second direction perpendicular to the first direction;
first and second support layers formed below a lower surface and above an upper surface, respectively, of the polarizing layer;
an adhesive layer formed below a lower surface of the first support layer; and
at least one color layer formed above the adhesive layer and mixed with a dye.

8. The polarizing plate of claim 7, wherein the at least one color layer includes a transparent resin which is mixed with the dye.

9. The polarizing plate of claim 7, wherein the dye absorbs light of a specific wavelength band.

10. The polarizing plate of claim 7, wherein the color layer is formed between the adhesive layer and the first support layer.

11. The polarizing plate of claim 7, wherein the color layer is formed on an upper surface of the second support layer.

12. The polarizing plate of claim 7, wherein the at least one color layer includes a first color layer formed on an upper surface of the second support layer and
a second color layer formed between the adhesive layer and the first support layer.

13. The polarizing plate of claim 12, wherein the first color layer and the second color layer are mixed with a first dye and a second dye, respectively.

14. A display apparatus comprising:
a display panel displaying an image;
a backlight unit disposed below the display panel to supply light; and
the polarizing plate of claim 7 disposed between the display panel and the backlight unit.
